(19) United States
(12) Patent Application Publication
(10) Pub. No.: US 2009/0285566 A1
(43) Pub. Date: Nov. 19, 2009

(54) VIDEO PROCESSING APPARATUS

(76) Inventors: Hitoshi SAIJO, Tokyo (JP); Yoshihisa KIZUKA, Tokyo (JP); Sayoko TANAKA, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/400,327

(22) Filed: Mar. 9, 2009

(30) Foreign Application Priority Data
May 13, 2008 (JP) P2008-125634

(51) Int. Cl. H04N 7/26

(52) U.S. Cl. 386/124; 386/E05.001

(57) ABSTRACT

A video processing apparatus includes: a control module configured to operate to: read out management information of a video data selected from among a plurality of sets of the video data stored in a storage module; write the management information of the selected video data in a memory module; calculate a total size of the selected video data based on the management information; control a data writing module to write the selected video data onto the recording medium; determine a split position for splitting the video data based on a writable capacity of the recording medium, when the total size of the selected video data is larger than the writable capacity of the recording medium; notifies the split position to a user; and split the selected video data at the split position to generate a plurality of split video data.

### CROSS REFERENCE TO RELATED APPLICATION(S)

The present disclosure relates to the subject matters contained in Japanese Patent Application No. 2008-125634 filed on May 13, 2008, which are incorporated herein by reference in its entirety.

### FIELD

The present invention relates to a video processing apparatus.

### BACKGROUND

Conventionally, there is a video processing apparatus that generates smaller pieces of data automatically by splitting one piece of data and copies the split data onto a plurality of recording medium in a case where the capacity of each of the recording medium is smaller than the size of the data to be copied. An example of such apparatus is disclosed in JP-A-2005-182931.

This conventional video processing apparatus is provided with: a storage module that stores data; a write module that writes data into a recording medium; and a control module that generates smaller pieces of data by splitting one piece of data into pieces of data each having a data size not larger than a data size allowed to be stored in a recording medium in a case where the data size of the data to be written into the recording medium is larger than the capacity of the recording medium so that the one piece of data cannot be entirely copied to the recording medium. Accordingly, even when the data size of data to be recorded is too large to be stored in one recording medium, the video processing apparatus can copy the data to a plurality of recording mediums if the plurality of recording mediums can be prepared.

In the conventional video processing apparatus according to the background art, it is however impossible for a user to confirm any split position until completion of writing of data into recording mediums even when the data is split into smaller pieces of data each having a data size allowed to be stored in a single recording medium. Accordingly, there is a problem that the data may be split into pieces in accordance with split positions unintended by the user because of the data size of the data and the writable capacity of each recording medium. Accordingly, the conventional video processing apparatus provides unsophisticated management efficiency of the data stored in the respective recording mediums.

### SUMMARY

Therefore, one of objects of the invention is to provide a video processing apparatus that is configured to be capable of splitting data having a data size not smaller than a writable capacity of each of recording mediums and store the split data in each of the recording mediums respectively by allowing to split the data in accordance with a desired split position.

According to a first aspect of the present invention, there is provided a video processing apparatus including: a memory module configured to store data; a data writing module configured to write data onto a recording medium; and a control module configured to operate to: read out management information of a video data selected from among a plurality of sets of the video data stored in a storage module; write the management information of the selected video data in the memory module; calculate a total size of the selected video data based on the management information; control the data writing module to write the selected video data onto the recording medium; determine a split position for splitting the video data based on a writable capacity of the recording medium, when the total size of the selected video data is larger than the writable capacity of the recording medium; notifies the split position to a user; and split the selected video data at the split position to generate a plurality of split video data.

According to a second aspect of the present invention, there is provided a video processing apparatus including: a memory module configured to store data; a data writing module configured to write data onto a recording medium; and a control module configured to operate to: read out management information of a video data selected from among a plurality of sets of the video data stored in a storage module; write the management information of the selected video data in the memory module; calculate a total size of the selected video data based on the management information; control the data writing module to write the selected video data onto the recording medium; determine a split position for splitting the video data to be smaller than a writable capacity of the recording medium, when the total size of the selected video data is larger than the writable capacity and an item included in the management information and used as a basis of splitting the selected video data is selected, the split position conforming to the selected item; notifies the split position to a user; and split the selected video data at the split position to generate a plurality of split video data.

According to a third aspect of the present invention, there is provided a video processing apparatus including: a memory module configured to store data; a data writing module configured to write data onto a recording medium; and a control module configured to operate to: read out management information of a video data selected from among a plurality of sets of the video data stored in a storage module; write the management information of the selected video data in the memory module; calculate a total size of the selected video data based on the management information; control the data writing module to write the selected video data onto the recording medium; determine a plurality of split positions for splitting the video data to be smaller than a writable capacity of the recording medium, when the total size of the selected video data is larger than the writable capacity and an item included in the management information and used as a basis of splitting the selected video data is selected, each of the split positions conforming to the selected item; notifies the split positions to a user; allowing a user to select one of the split positions; and split the selected video data at the selected split position to generate a plurality of split video data.

### BRIEF DESCRIPTION OF THE DRAWINGS

A general configuration that implements the various feature of the invention will be described with reference to the drawings. The drawings and the associated descriptions are provided to illustrate embodiments of the invention and not to limit the scope of the invention.

FIG. 1 is a perspective view showing a video processing apparatus according to a first embodiment of the invention.

FIG. 2 is a block diagram showing the configuration of the video processing apparatus according to the first embodiment of the invention.

FIGS. 3A to 3C show schematic views showing respective video data in the first embodiment of the invention, in which FIG. 3A shows video data 120, FIG. 3B shows write-selected video data 120A, and FIG. 3C shows video data 30A and 30B.

FIG. 4 is a schematic view showing an example of a video data write screen displayed by a video data write program in the first embodiment of the invention.

FIG. 5 is a schematic view showing an example of operation of the video processing apparatus according to the first embodiment of the invention.

FIG. 6 is a flow chart showing an example of operation of the video processing apparatus according to the first embodiment of the invention.

FIG. 7 is a schematic view showing an example of a video data write screen displayed by a video data write program in a second embodiment of the invention.

FIG. 8 is a schematic view showing an example of operation of a video processing apparatus according to the second embodiment of the invention.

FIG. 9 is a flow chart showing an example of operation of the video processing apparatus according to the second embodiment of the invention.

FIG. 10 is a schematic view showing an example of a video data write screen displayed by a video data write program in a third embodiment of the invention.

FIG. 11 is a schematic view showing an example of operation of a video processing apparatus according to the third embodiment of the invention.

FIG. 12 is a flow chart showing an example of operation of the video processing apparatus according to the third embodiment of the invention.

### DETAILED DESCRIPTION OF THE EMBODIMENTS

Hereinafter, embodiments of the invention will be described. In the following description, the same or similar components will be referenced by the same reference numerals, and detailed description thereof will be omitted.

### First Embodiment

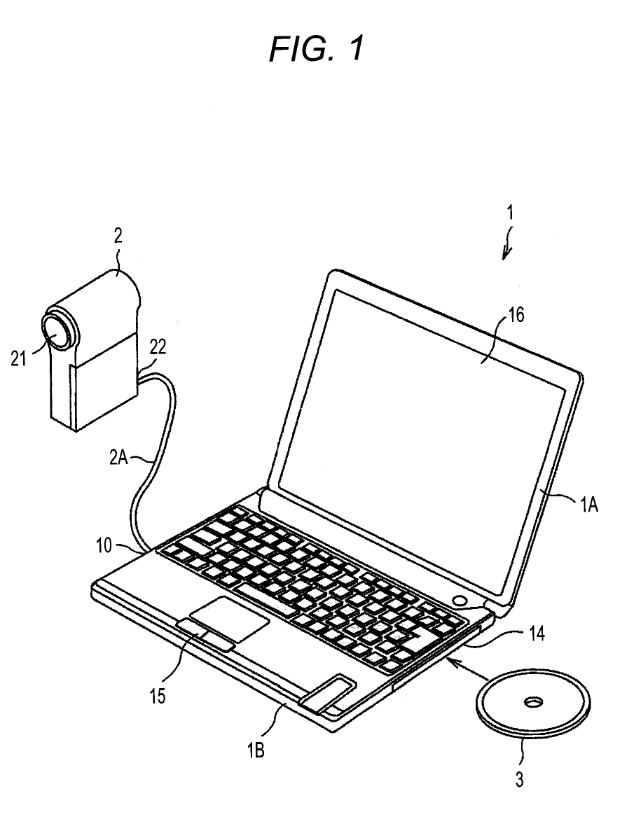

FIG. 1 is a perspective view showing a video processing apparatus according to a first embodiment of the invention.

The video processing apparatus 1 is connected to a video recording apparatus 2 by a Universal Serial Bus (USB) cable 2A so that the video processing apparatus 1 and the video recording apparatus 2 can communicate with each other. The video processing apparatus 1 can receive video information taken by the video recording apparatus 2 and record the received video information onto a recording medium, for example, on an optical disc 3.

The video processing apparatus 1 includes an upper casing 1A and a lower casing 1B. The upper casing 1A is connected to the lower casing 1B by a hinge so as to be opened and closed desirably. The upper casing 1A has a display module 16 that is provided with a display device such as a liquid crystal display panel for displaying characters and images. The lower casing 1B has electronic components such as a CPU (Central Processing Unit) and an HDD (Hard Disk Drive) provided inside the lower casing 1B. An optical disc drive 14, a USB terminal 10 and a user interface module 15 are provided in an upper surface of the lower casing 1B. The optical disc drive 14 can read/write data from/into the optical disc 3 which is a recording medium such as a DVD (Digital Versatile Disc). The USB terminal 10 is capable to be connected to an external apparatus through the USB (Universal Serial Bus) cable 2A. The user interface module 15 includes a keyboard for inputting characters and commands, and a pointing device.

The video recording apparatus 2 has an image pickup module 21, and a USB terminal 22. The image pickup module 21 includes an optical system including a plurality of lens groups, and an image pickup device such as a CDD (Charge Coupled Device). The USB terminal 22 is capable to be connected to an external apparatus through the USB cable 2A. The video recording apparatus 2 records video data captures a video image and stores the video image as the video data on a storage module provided in a body of the video recording apparatus 2. For example, the video data is recorded in accordance with a video format such as DVD-Video, MPEG-4, and H.264. It is also acceptable that the configuration may be made so that video data recorded on a memory card or a removable medium such as a DVD as well as on the video recording apparatus 2 is handled by the video processing apparatus 1.

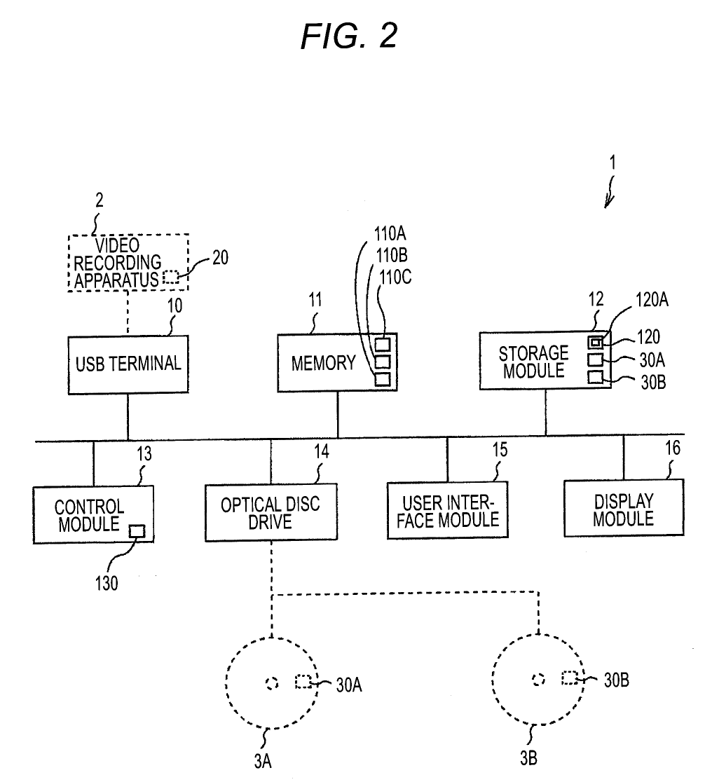

FIG. 2 is a block diagram showing the configuration of the video processing apparatus according to the first embodiment of the invention.

The video processing apparatus 1 has a USB terminal 10, a memory 11, a storage module 12 such as an HDD, a control module 13, an optical disc drive 14, a user interface module 15, and a display module 16. The USB terminal 10 exchanges data with the video recording apparatus 2 through the USB cable 2A inserted into the USB terminal 10. The memory 11 temporarily stores information to assist processes of the respective components. The storage module 12 stores information so that the information can be read/written from/into the storage module 12. The control module 13 operates a program while controlling operation of the respective portions. The optical disc drive 14 can read/write information from/into an optical disc such as a DVD. The user interface module 15 includes a keyboard including a set of switches allocated for respective operation functions, and a track pad. The display module 16 displays characters and images on a liquid crystal display panel such as an LCD (Liquid Crystal Display).

The USB terminal 10 receives video data 20 stored in the storage module of the connected video recording apparatus 2.

The memory 11 temporarily stores video data management information 11A, write-selected video data management information 110B and split video data management information 110C. The video data management information 110A is management information contained in video data 120 stored in the storage module 12 or video data 20 stored in the video recording apparatus 2 and expresses details of contents contained in the video data 120 or the video data 20. The write-selected video data management information 110B is management information contained in write-selected video data 120A selected from the video data 120 or the video data 20 and expresses details of contents contained in the write-selected video data 120A. The split video data management information 110C is management information of data into which the write-selected video data 120A is split. The video data 120 and the video data 20 are different from each other in terms of places they are stored but equal in data configuration and data handling operation to each other. Accordingly, the video data 120 will be used as a representative in the following description.

The storage module 12 stores video data 120, write-selected video data 120A and video data 30A and 30B. The video data 120 is video data which is copied from the video data 20 of the video recording apparatus 2 or recorded in the video processing apparatus 1. The write-selected video data 120A is video data which is selected from the video data 120 by a user. The video data 30A and 30B are data generated by splitting the write-selected video data 120A.

The control module 13 operates a video data write program 130 which generates video data 30A and 30B in the storage module 12 based on the split video data management information 110C temporarily stored in the memory 11 and writes the video data 30A and 30B into optical mediums 3A and 3B respectively through the optical disc drive 14.

The optical disc drive 14 splits the write-selected video data 120A into the video data 30A and 30B and writes the split ones 30A and 30B into the inserted optical mediums 3A and 3B respectively. Incidentally, configuration may be made so that the optical mediums 3A and 3B may be inserted one after another, or configuration may be made so that the optical mediums 3A and 3b are inserted simultaneously.

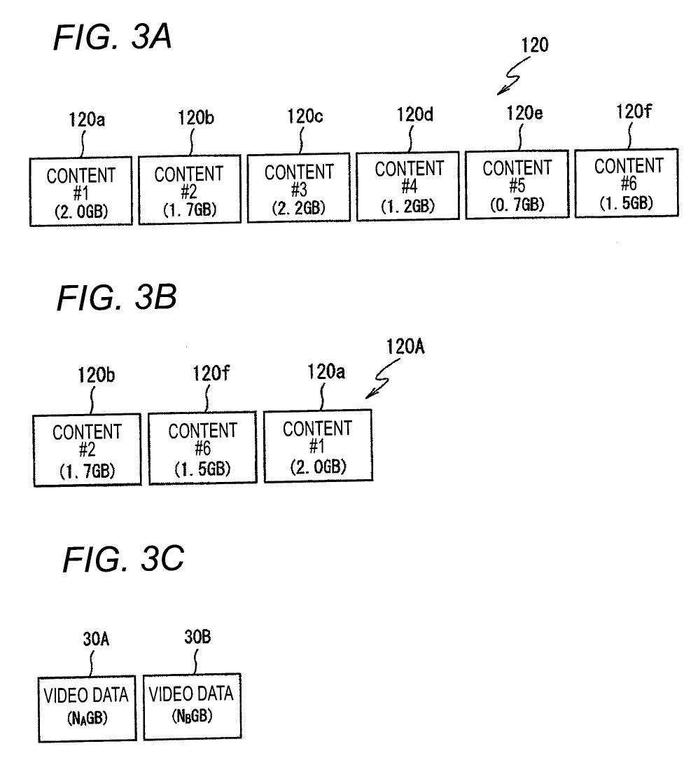

FIGS. 3A to 3C are schematic views showing video data in the first embodiment of the invention. FIG. 3A shows video data 120. FIG. 3B shows write-selected video data 120A. FIG. 3C shows video data 30A and 30B.

The video data 120 is stored in the storage module 12 and has contents 120a to 120f. The write-selected video data 120A is a part of the video data 120 and has contents selected from the video data 120 by a user. For example, the write-selected video data 120A has contents 120b, 120f and 120a. The video data 30A is one of pieces of video data into which the write-selected video data 120A is split. The video data 30A has a data size NA. The video data 30B is the other of the pieces of video data into which the write-selected video data 120A is split. The video data 30B has a data size NB. Incidentally, NA and NB are data sizes determined by the video data write program 130. Details of the determination method will be described later.

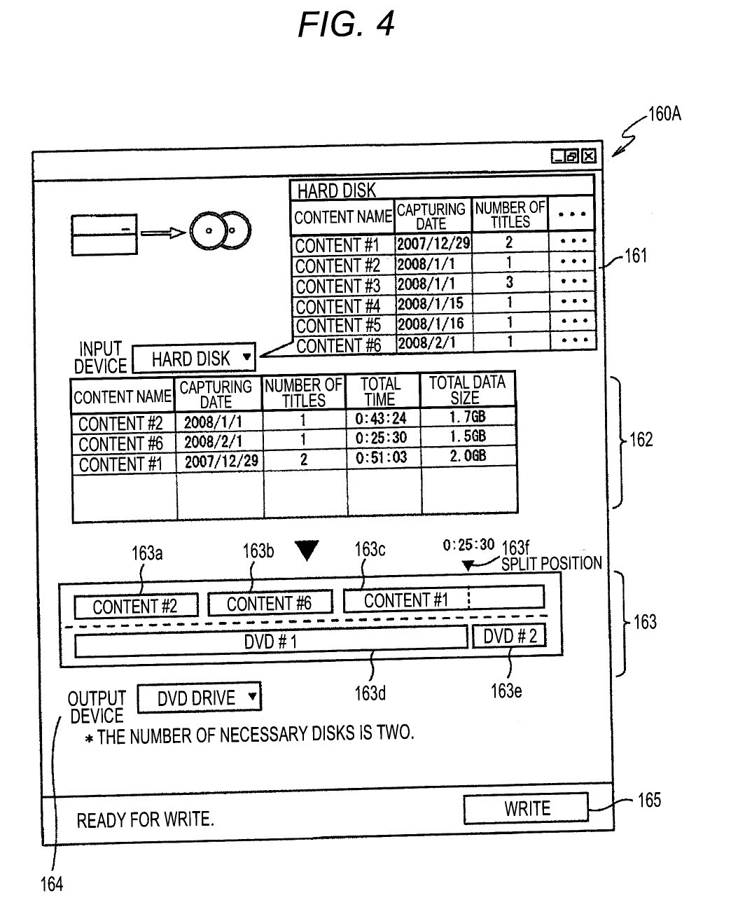

FIG. 4 is a schematic view showing an example of a video data write screen displayed by the video data write program in the first embodiment of the invention.

The video data write screen 160A displayed by the video data write program 130 has an input device contents display module 161, a write-selected video data display module 162, a write contents display module 163, an output device contents display module 164, and a write button 165. The input device contents display module 161 acquires video data management information 110A from video data 20 in the video recording apparatus 2 or from video data 120 in the storage module 12, and displays a list of details of contents. The write-selected video data display module 162 acquires write-selected video data management information 110B, and displays details of contents selected as the write-selected video data 120A in the input device contents display module 161. The write contents display module 163 displays correspondence between contents as the write-selected video data 120A displayed in the write-selected video data display module 162 and optical mediums 3A and 3B as destinations of storage of the contents. The output device contents display module 164 displays a selected output device. The write button 165 is provided for starting writing of data into the optical mediums 3A and 3B based on the contents displayed in the video data write screen 160A.

The input device contents display module 161 displays detailed information of the video data 20 or the video data 120. For example, the detailed information includes names of contents, capturing dates, respective numbers of titles, etc. In addition, the input device contents display module 161 displays the content of an input device when another storage device than the video recording apparatus 2 and the storage module 12 is connected as the input device.

The write-selected video data display module 162 displays detailed information of the write-selected video data 120A. For example, the detailed information includes names of contents, capturing dates, respective numbers of titles, total times, total data sizes, etc. Incidentally, though not shown, thumbnails of respective contents may be displayed.

The write contents display module 163 displays contents 163a to 163c contained in the write-selected video data 120A and DVDs 163d and 163e as the optical mediums 3A and 3B while a time axis is taken in a horizontal direction in FIG. 4. With respect to the content 163c, a split position 163f between the DVD 163d and the DVD 163e is displayed together with the playback time of the content 163c.

When output device another than the DVD drive is connected as the optical disc drive 14, the output device contents display module 164 enables selection from candidates for the output device.

The write button 165 is enabled to be operated when all necessary settings in the video data write screen 160A are completed and the optical disc 3A or 3B is inserted into the optical disc drive 14.

Operation of the video processing apparatus in the embodiment of the invention will be described below with reference to the respective drawings.

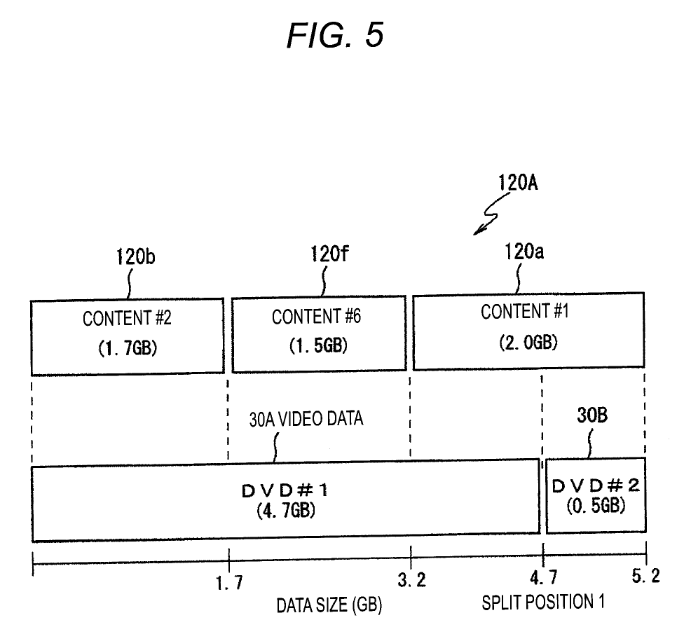

FIG. 5 is a schematic view showing an example of operation of the video processing apparatus according to the first embodiment of the invention.

When optical mediums 3A and 3B are DVDs each having a writable capacity of 4.7 GB, the video data write program 130 writes video data 30A having a data size of 4.7 GB equal to the maximum writable capacity into the first optical disc 3A. Then, the video data write program 130 writes video data 30B having the remaining data size of 0.5 GB into the second optical disc 3B. Therefore, the content 120a is split in accordance with a split position 1 where the data size reaches 4.7 GB inclusive of the data sizes of the contents 120b and 120f.

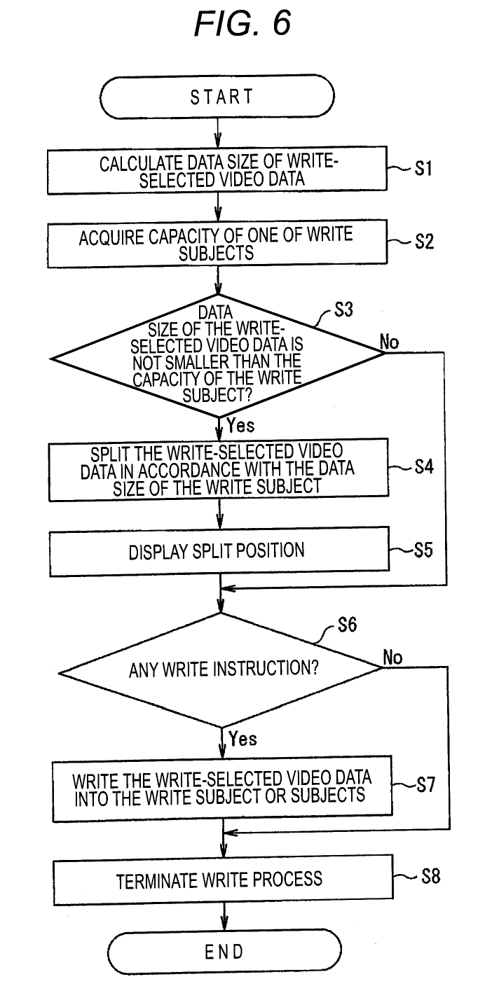

FIG. 6 is a flow chart showing an example of operation of the video processing apparatus according to the first embodiment of the invention.

First, the video data write program 130 calculates the data size of write-selected video data 120A selected in the write-selected video data display module 162 based on write-selected video data management information 110B (S1). Then, the video data write program 130 acquires the capacity of one of optical mediums 3A and 3B selected as write subjects in the output device contents display module 164 (S2).

Then, the video data write program 130 compares the data size of the write-selected video data 120A with the capacity of one of the optical mediums 3A and 3B as write subjects. When the data size of the write-selected video data 120A is larger (Yes in S3), the video data write program 130 generates split video data management information 110C for splitting the write-selected video data 120A by the capacity (e.g. 4.7 GB) of one of the optical mediums 3A and 3B as write subjects (S4). Then, the video data write program 130 acquires a split position 163f indicating a position on the split data size from the split video data management information 110C and displays the split position 163f on the write contents display module 163 (S5).

When the step S3 results in that the data size of the write-selected video data 120A is smaller (No in S3), the video data write program 130 does not split the write-selected video data 120A but proceeds forward to a step S6.

Then, upon reception of a write instruction due to an operation on the write button 165 (Yes in S6), the video data write program 130 generates video data 30A and 30B as images in the storage module 12 based on the split video data management information 110C and writes the video data 30A and 30B into the optical mediums 3A and 3B respectively through the optical disc drive 14 when the write-selected video data 120A is split (S7). On the other hand, when the write-selected video data 120A is not split, the video data write program 130 writes the write-selected video data 120A through the optical disc drive 14 without any splitting of the write-selected video data 120A. Then, the video data write program 130 is terminated (S8).

When the step S6 results in that the video data write program 130 is terminated without any write instruction (No in S6), the operation is terminated (S8).

According to the first embodiment, the video data write program 130 splits the write-selected video data 120A in accordance with the capacity of a write subject and presents the split position 163f in the write contents display module 163 when the data size of the write-selected video data 120A is larger than the capacity of the write subject. Therefore, when the split position 163f is not a split position desired by the user, it is possible to take measures to change the selection content of the write-selected video data 120A to thereby change the split position to a desired position.

Although description has been made on the case where the write-selected video data 120A is split into two, the invention can be also applied to the case where the write-selected video data 120A is split into three or more. In addition, the invention is not limited to video data but can be applied to the case where different kinds of data are mixed.

### Second Embodiment

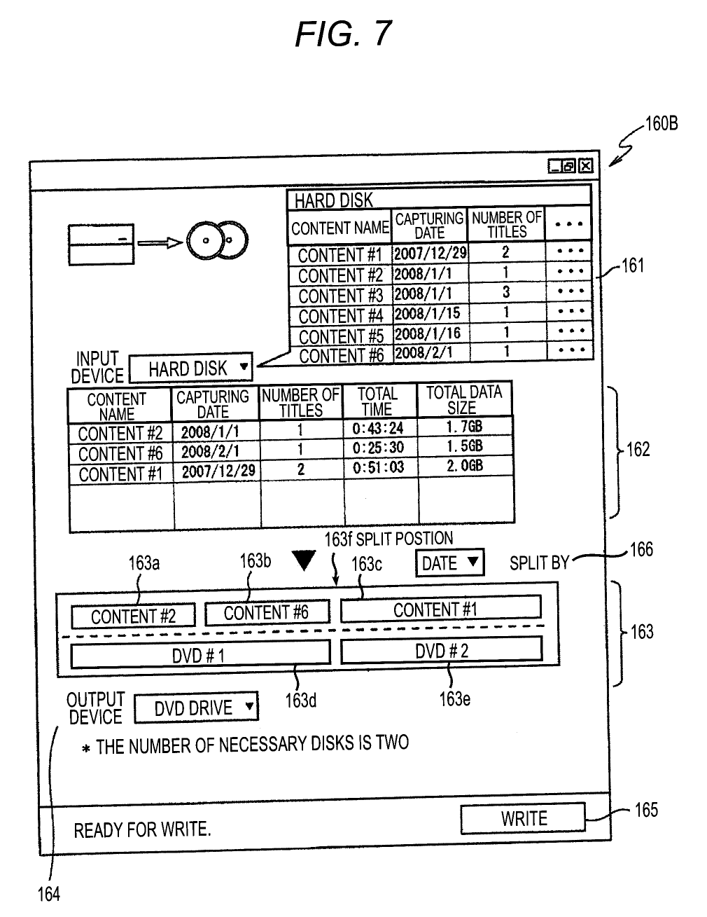

FIG. 7 is a schematic view showing an example of a video data write screen displayed by a video data write program in a second embodiment of the invention. Incidentally, parts having the same configurations and functions as those in the first embodiment are referred to by the same reference numerals in the following description.

A video data write screen 160B has a split contents display module 166 in addition to the configuration of the video data write screen 160A described in the first embodiment. The split contents display module 166 displays split contents for determining split positions of the write-selected video data 120A. For example, a selection pull-down menu or the like can be used for determining a split content from a plurality of kinds such as date, title, chapter, etc.

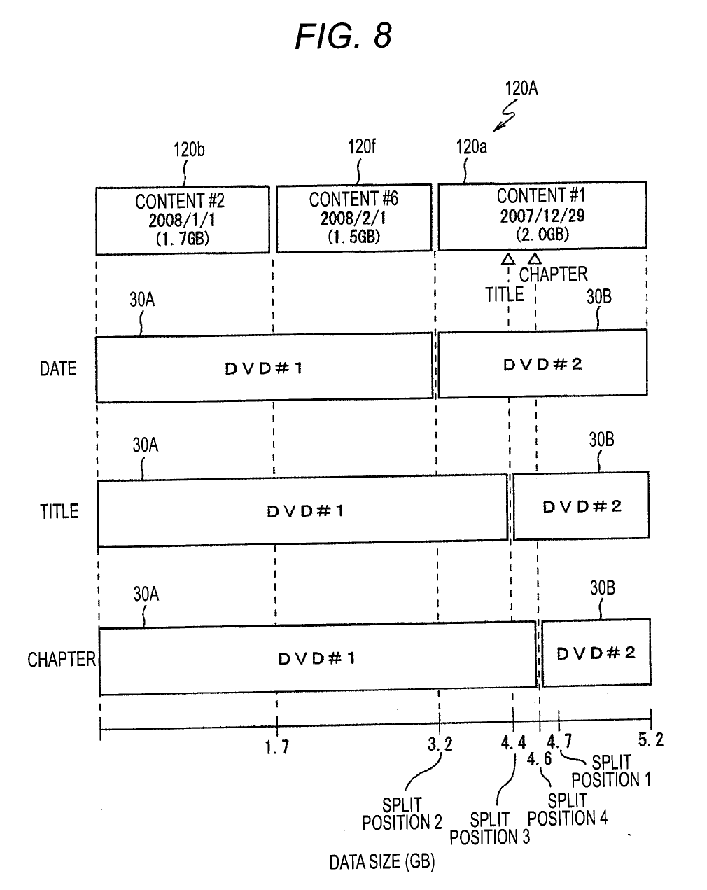

FIG. 8 is a schematic view showing an example of operation of a video processing apparatus according to the second embodiment of the invention.

When optical mediums 3A and 3B are DVDs each having a writable capacity of 4.7 GB, a video data write program 130 writes video data 30A having a data size not larger than the capacity of 4.7 GB equal to the maximum writable capacity into the first optical disc 3A. However, the split position for determining the data size of the video data 30A changes in accordance with the split content selected in the split contents display module 166.

When, for example, “date” is selected in the split contents display module 166, the video data write program 130 compares dates of respective contents with one another, detects a boundary of a date closest to the writable capacity of the optical disc 3A, and determines a split position 2 (3.2 GB).

When, for example, “title” is selected in the split contents display module 166, the video data write program 130 compares title start positions of respective contents with one another, detects a title start position closest to the writable capacity of the optical disc 3A, and determines a split position 3 (4.4 GB).

When, for example, “chapter” is selected in the split contents display module 166, the video data write program 130 compares chapter start positions of respective contents with one another, detects a chapter start position closest to the writable capacity of the optical disc 3A, and determines a split position 4 (4.6 GB).

Incidentally, video data 30B having the remaining data size is written into the second optical disc 3B.

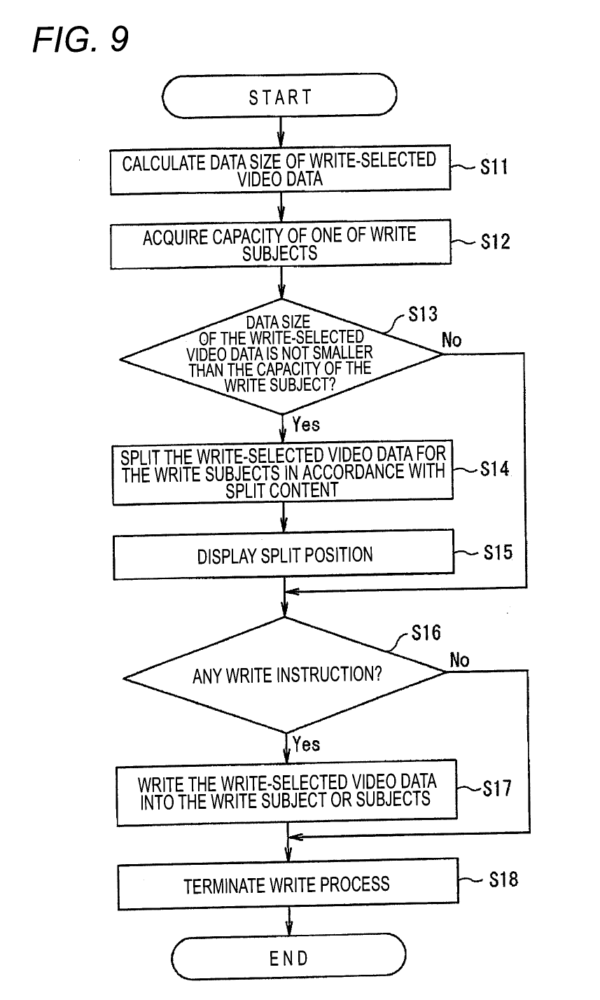

FIG. 9 is a flow chart showing an example of operation of the video processing apparatus according to the second embodiment of the invention.

First, the video data write program 130 calculates a data size of the write-selected video data 120A selected in the write-selected video data display module 162 from the write-selected video data management information 110B (S11). Then, the video data write program 130 acquires the capacity of one of the optical mediums 3A and 3B selected as write subjects in the output device contents display module 164 (S12).

Then, the video data write program 130 compares the data size of the write-selected video data 120A with the capacity of one of the optical mediums 3A and 3B as write subjects. When the data size of the write-selected video data 120A is larger (Yes in S13), the video data write program 130 detects a split position closest to but not larger than the capacity of the write subject based on the split content selected in the split contents display module 166, and generates split video data management information 110C for splitting the write-selected video data 120A (S14) Then, the video data write program 130 acquires a split position 163f indicating a position on the split data size from the split video data management information 110C and displays the split position 163f on the write contents display module 163 (S15).

When the step S13 results in that the data size of the write-selected video data 120A is smaller (No in S13), the video data write program 130 does not split the write-selected video data 120A but proceeds forward to a step S16.

Then, upon reception of a write instruction due to an operation on the write button 165 (Yes in S16), the video data write program 130 generates video data 30A and 30B as images in the storage module 12 based on the split video data management information 110C and writes the video data 30A and 30B into the optical mediums 3A and 3B respectively through the optical disc drive 14 when the write-selected video data 120A is split (S17). On the other hand, when the write-selected video data 120A is not split, the video data write program 130 writes the write-selected video data 120A through the optical disc drive 14 without any splitting of the write-selected video data 120A. Then, the video data write program 130 is terminated (S18).

When the step S16 results in that the video data write program 130 is terminated without any write instruction (No in S16), the operation is terminated (S18).

According to the second embodiment, the video data write program 130 splits the write-selected video data 120A based on the split content and presents the split position 163f in the write contents display module 163 when the data size of the write-selected video data 120A is larger than the capacity of the write subject. Therefore, in addition to the advantage of the first embodiment, the split position 163f can be changed to a split position desired by the user. Moreover, the video data write program 130 does not generate the video data 30A and 30B as images in the storage module 12 unless the write button 165 is operated. Accordingly, the content to be selected in the split contents display module 166 can be changed to thereby make it easy to change the split position.

### Third Embodiment

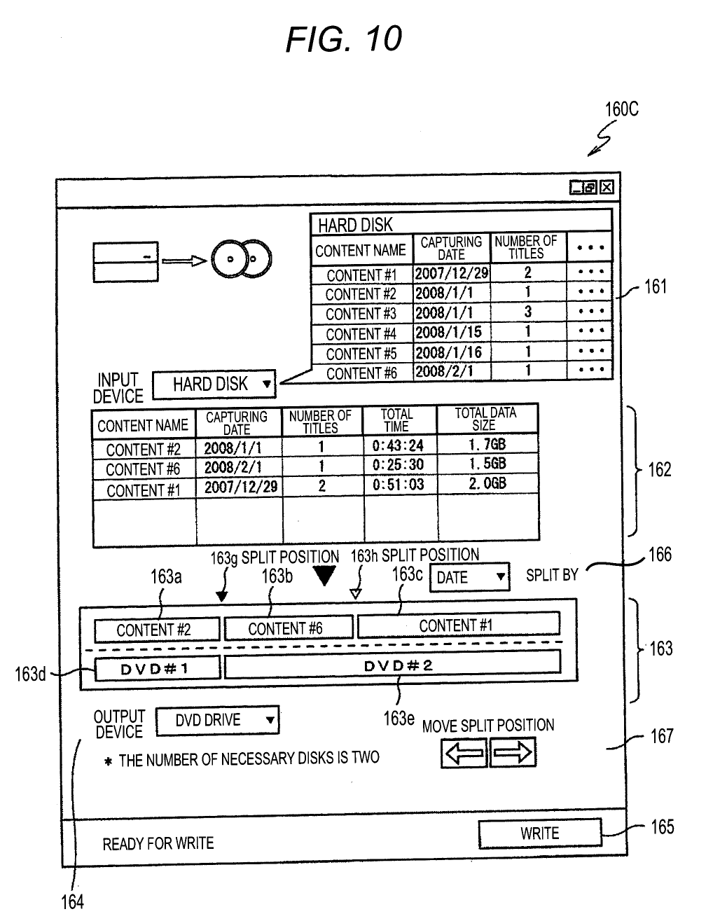

FIG. 10 is a schematic view showing an example of a video data write screen displayed by a video data write program in a third embodiment of the invention.

The video data write screen 160C has a split position selection button 167 in addition to the configuration of the video data write screen 160B described in the second embodiment. The split position selection button 167 is an operation button for selecting a split position 163g or 163h of the write-selected video data 120A. In addition, the split positions 163g and 163h are split positions detected based on the split content selected in the split contents display module 166.

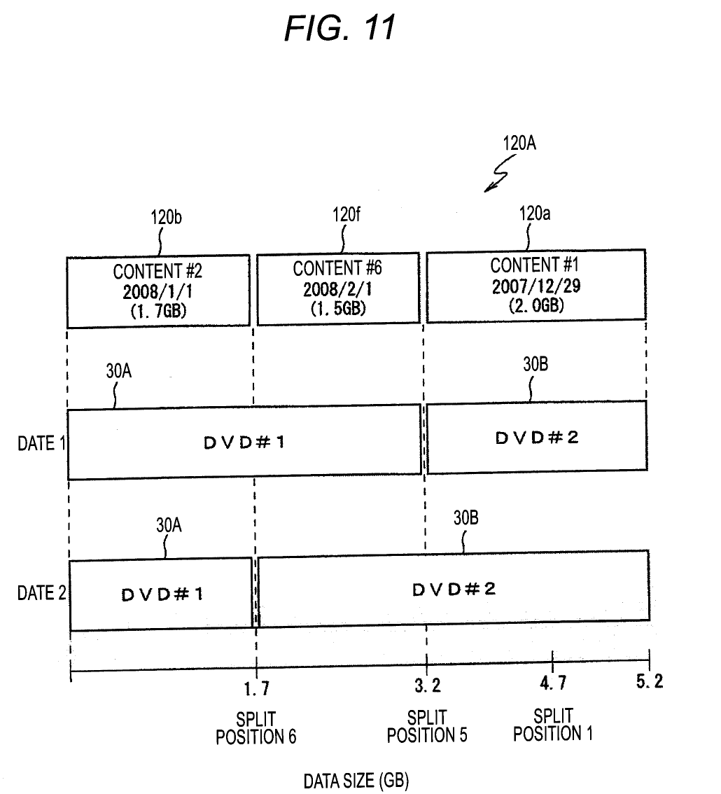

FIG. 11 is a schematic view showing an example of operation of a video processing apparatus according to the third embodiment of the invention.

When optical mediums 3A and 3B are DVDs each having a writable capacity of 4.7 GB, the video data write program 130 writes video data 30A having a data size not larger than the data size of 4.7 GB equal to the maximum writable capacity into the first optical disc 3A. However, split positions for determining the data size of the video data 30A are detected in the write-selected video data 120A based on the split content selected in the split contents display module 166.

When, for example, “date” is selected in the split contents display module 166, the video data write program 130 compares dates of respective contents with one another and detects a split position 5 (3.2 GB) and a split position 6 (1.7 GB) from boundaries of dates.

Incidentally, video data 30B having the remaining data size is written into the second optical disc 3B.

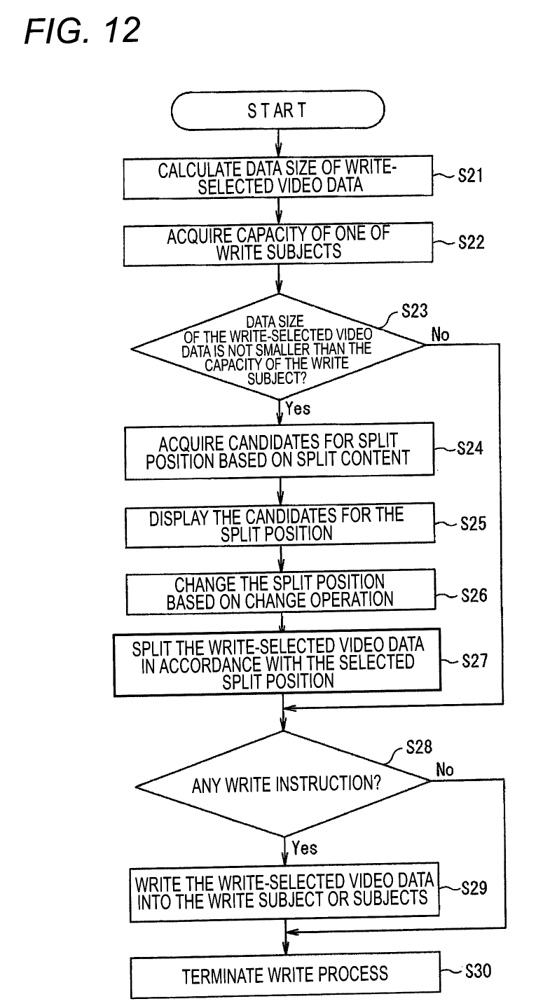

FIG. 12 is a flow chart showing an example of operation of the video processing apparatus according to the third embodiment of the invention.

First, the video data write program 130 calculates the data size of the write-selected video data 120A selected in the write-selected video data display module 162 from the write-selected video data management information 110B (S21). Then, the video data write program 130 acquires the capacity of one of the optical mediums 3A and 3B selected as write subjects in the output device contents display module 164 (S22).

Then, the video data write program 130 compares the data size of the write-selected video data 120A with the capacity of one of the optical mediums 3A and 3B as write subjects. When the data size of the write-selected video data 120A is larger (Yes in S23), the video data write program 130 detects candidates for a split position based on the split content selected in the split contents display module 166 (S24). Then, the video data write program 130 displays split positions 163g and 163h on the write contents display module 163 so that the split positions 163g and 163h indicate positions on the data size as the candidates for the split position (S25).

Then, the video data write program 130 changes the split position based on a change operation made on the split position selection button 167 (S26). The video data write program 130 generates split video data management information 110C for splitting the write-selected video data 120A in the selected split position (S27).

When the step S23 results in that the data size of the write-selected video data 120A is smaller (No in S23), the video data write program 130 does not split the write-selected video data 120A but proceeds forward to a step S28.

Then, upon reception of a write instruction due to an operation on the write button 165 (Yes in S28), the video data write program 130 generates video data 30A and 30B as images in the storage module 12 based on the split video data management information 110C and writes the video data 30A and 30B into the optical mediums 3A and 3B respectively through the optical disc drive 14 when the write-selected video data 120A is split (S29). On the other hand, when the write-selected video data 120A is not split, the video data write program 130 writes the write-selected video data 120A through the optical disc drive 14 without splitting of the write-selected video data 120A. Then, the video data write program 130 is terminated (S30).

When the step S28 results in that the video data write program 130 is terminated without any write instruction (No in S28), the operation is terminated (S30).

According to the third embodiment, candidates for the split position for splitting the write-selected video data 120A based on the split content are displayed and the video data is split in accordance with one candidate selected as the split position from the candidates for the split position. Accordingly, in addition to the advantage of the second embodiment, the split position can be changed to a split position desired by the user. Moreover, the video data 30A and 30B are not generated as images in the storage module 12 unless the write button 165 is operated. Accordingly, the split position selection button 167 can be operated to thereby make it easy to change the split position.

As described above with reference to the embodiments, in the video processing apparatus according to the invention, data having a data size not smaller than a writable capacity of each of recording mediums is split into smaller pieces of data so that the split ones can be stored in the recording mediums respectively. Moreover, the data can be split in accordance with a desired split position.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A video processing apparatus comprising:
a memory module configured to store data;
a data writing module configured to write data onto a recording medium; and
a control module configured to operate to:
read out management information of a video data selected from among a plurality of sets of the video data stored in a storage module;
write the management information of the selected video data in the memory module;
calculate a total size of the selected video data based on the management information;
control the data writing module to write the selected video data onto the recording medium;
determine a split position for splitting the video data based on a writable capacity of the recording medium, when the total size of the selected video data is larger than the writable capacity of the recording medium;
notifies the split position to a user; and
split the selected video data at the split position to generate a plurality of split video data.

2. The apparatus according to claim 1, wherein the control module controls the data writing module to write each of the split video data onto respective one of a plurality of recording mediums.

3. The apparatus according to claim 1, wherein the control module reads out the management information of the selected video data from an external storage device set as the storage module.

4. The apparatus according to claim 1 further comprising a storage device configured to store the sets of the video data,
wherein the control module reads out the management information of the selected video data from the storage device set as the storage module.

5. A video processing apparatus comprising:
a memory module configured to store data;
a data writing module configured to write data onto a recording medium; and
a control module configured to operate to:
read out management information of a video data selected from among a plurality of sets of the video data stored in a storage module;
write the management information of the selected video data in the memory module;
calculate a total size of the selected video data based on the management information;
control the data writing module to write the selected video data onto the recording medium;
determine a split position for splitting the video data to be smaller than a writable capacity of the recording medium, when the total size of the selected video data is larger than the writable capacity and an item included in the management information and used as a basis of splitting the selected video data is selected, the split position conforming to the selected item;
notifies the split position to a user; and
split the selected video data at the split position to generate a plurality of split video data.

6. The apparatus according to claim 5, wherein the control module controls the data writing module to write each of the split video data onto respective one of a plurality of recording mediums.

7. The apparatus according to claim 5, wherein the control module reads out the management information of the selected video data from an external storage device set as the storage module.

8. The apparatus according to claim 5 further comprising a storage device configured to store the sets of the video data,
wherein the control module reads out the management information of the selected video data from the storage device set as the storage module.

9. A video processing apparatus comprising:
a memory module configured to store data;
a data writing module configured to write data onto a recording medium; and
a control module configured to operate to:
read out management information of a video data selected from among a plurality of sets of the video data stored in a storage module;
write the management information of the selected video data in the memory module;
calculate a total size of the selected video data based on the management information;
control the data writing module to write the selected video data onto the recording medium;
determine a plurality of split positions for splitting the video data to be smaller than a writable capacity of the recording medium, when the total size of the selected video data is larger than the writable capacity and an item included in the management information and used as a basis of splitting the selected video data is selected, each of the split positions conforming to the selected item;
notifies the split positions to a user;
allowing a user to select one of the split positions; and
split the selected video data at the selected split position to generate a plurality of split video data.

10. The apparatus according to claim 9, wherein the control module controls the data writing module to write each of the split video data onto respective one of a plurality of recording mediums.

11. The apparatus according to claim 9, wherein the control module reads out the management information of the selected video data from an external storage device set as the storage module.

12. The apparatus according to claim 9 further comprising a storage device configured to store the sets of the video data,
wherein the control module reads out the management information of the selected video data from the storage device set as the storage module.
